(19) United States
(12) Patent Application Publication
(10) Pub. No.: US 2025/0229240 A1
(43) Pub. Date: Jul. 17, 2025

(54) MODULAR BARREL AGITATING AND STORAGE SYSTEM

(71) Applicant: Kevin Rowe, New Haven, KY (US)

(72) Inventor: Kevin Rowe, New Haven, KY (US)

(21) Appl. No.: 18/415,044

(22) Filed: Jan. 17, 2024

(51) Int. Cl. B01F 35/32; A47B 81/00; B01F 31/20; B01F 35/221; B01F 35/43; B01F 35/60

(52) U.S. Cl. CPC B01F 35/3203; A47B 81/007; B01F 31/201; B01F 35/2216; B01F 35/43; B01F 35/605

(57) ABSTRACT

A modular barrel storage and mixing system. Each module is designed to hold a 600 lb barrel, and the modules may be stacked up to 3 units high, with interlocking components for stability. Agitation of each barrel is controlled pneumatically, using a pressure regulator and drier, an emergency cutoff control valve, a pneumatic variable timer, a 3-way directional control valve, a limit switch and a pneumatic cylinder.

### SUMMARY OF THE INVENTION

A modular mixing system made from 2″ steel tubing welded to form a frame suitable for 53 gallon, 59 gallon and other various size wooden barrels. Each unit interlocks with those above and below, such that they may be stacked up to 3 units high, is forklift accessible on all 4 sides, and pneumatically controlled agitation is used to mix the content of the barrels.

### BRIEF DESCRIPTION OF DRAWINGS

FIG. 1 shows a top view of the modular barrel storage system.

FIG. 2 shows a perspective view of the pressure regulator.

FIG. 3 shows a perspective view of the switch down motion timer.

FIG. 4 shows a perspective view of 3 way switching valve.

FIG. 5 shows a perspective view of the modular barrel storage system.

FIG. 6 shows a side view of the modular barrel storage system.

FIG. 7 shows an end view of the modular barrel storage system.

FIG. 8 shows a perspective view of the pneumatic cylinder.

FIG. 9 shows a top view of the cradle.

FIG. 10 shows a perspective view of the cradle.

FIG. 11 shows an end view of the cradle.

FIG. 12 shows a side view of the cradle.

FIG. 13 shows a top view of the frame.

FIG. 14 shows a perspective view of the interlocking pins.

FIG. 15 shows a perspective view of the mount for the drier and manifold.

FIG. 16 shows a perspective view of the frame.

FIG. 17 shows a side view of the frame.

FIG. 18 shows an end view of the frame.

FIG. 19 shows the mount for the emergency cut off valve.

FIG. 20 shows a perspective view of the emergency cut off valve.

FIG. 21 shows a perspective view of the pressure regulator and manifold.

FIG. 22 shows a perspective view of the backside of the manifold.

FIG. 23 shows a perspective view of the variable timer.

FIG. 24 shows a perspective view of the variable timer.

FIG. 25 shows a perspective view of the mount for the variable timer.

FIG. 26 shows a perspective view of the variable timer.

FIG. 27 shows a side view of the pneumatic cylinder.

FIG. 28 shows a perspective view of the pneumatic cylinder.

### DETAILED DESCRIPTION OF THE INVENTION

In the following description, numerous specific details are set forth to clearly describe the embodiments disclosed herein. However, one skilled in the art will understand that some well-known features have not been described in detail so as not to obscure the invention.

In the following description, like reference numbers are used to identify like elements. Furthermore, the drawings are intended to illustrate major features of the exemplary embodiments in a diagrammatic manner. The drawings are not intended to depict every feature of every implementation and are not drawn to scale.

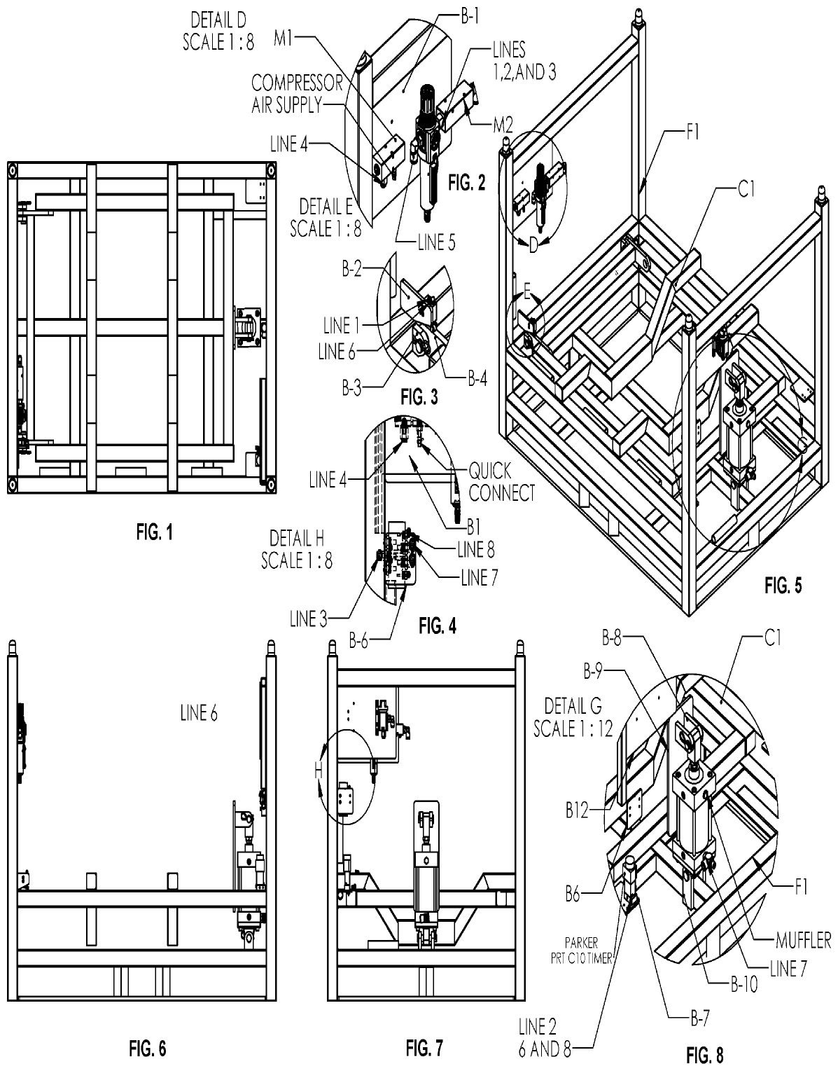

Each frame module is made from 2″×2″ steel tubing. As illustrated in FIGS. 1 through 8, the units comprise an external frame (F1) and a floating cradle (C1). The external frame (F1) and the floating cradle (C1) interlocking via pins through (B3 and B4). The storage system may be stacked up to 3 units high. The units are configured to enable movement via forklift from all 4 sides. For the purpose of the following description, the back left side of the unit as seen in FIGS. 5 and 16 will be referred to as the back, and the front right side of the unit will be referred to as the front.

The external frame is 39 inches wide left to right and 53 inches long from back to front and 40.5 inches tall. The external frame has 4 vertical posts, one at each corner, with an indent in the bottom and mounting pins on the top to enable interlocked stacking of up to 3 frames. The external frame has front, back, left, and right lower posts, which form a rectangle, and front, back, left, and right lower rail posts, which form a rectangle of identical dimensions to the rectangle formed by the lower posts. The external frame also has front and back upper rails, which are the same lengths as the front and back rails.

The barrel stored in a unit is secured via the floating cradle (C1). The floating cradle is also made of 2×2″ steel tubing. The agitation of the barrel is caused by movement of the floating cradle. Movement of the cradle is pneumatically controlled and caused. The pneumatic motion control system has 7 components: (1) manifold (M1) located on B1. (2) The on/off valve, emergency cut off valve located on B12 (sheet 4). (3) adjustable pressure regulator, drier and manifold 2 located on B1. (4) Limit switch for down motion timer located on B2. (5) Variable timer for lift motion located on B7. (6) 3 way switching valve 5 port 2 position located on B6. (7) pneumatic cylinder 4″ diameter with 4″ travel connected to B8 and B10. Each of these components has a corresponding mount, illustrated with corresponding labels B1 for the manifold and pressure regulator and drier mount, B12 for the emergency cutoff and control valve mount, B7 for the pneumatic variable timer mount (2), B6 for the 3 way directional control valve mount, B2 for the limit switch mount, and B8 and B10 for the pneumatic cylinder mounts.

The pressure regulator and drier (is mounted at the back on B1 (defined as the left back side of the module as illustrated in the figures) of the modular container system. The pressure regulator and drier on mount B1 provides dry air to the emergency cutoff and control valve located on B12.

The emergency cutoff and control valve located on B12 controls the system by controlling the supply of dry air, and also serves as an emergency cutoff. The emergency cutoff and control valve has 2 air supply lines coming off it, air supply coming in from M1 manifold mounted on B1 supplies air to the cut off switch and the return line feeds air supply to the drier, regulator on B1 and supplies air thru the large manifold (M2) connections to 3 components. The 3 way switching valve on B6 (also called a 3 way-2 position-5 port) uses Line 3 on M2. Limit switch on B2 uses line 1 from M2. Variable timer on B7 uses line 2 from M2. These 3 components have a continuous air supply.

The pneumatic timer on B7 starts the system into motion. When it reaches the set time limit, the timer sends an air signal to the 3 way switching valve by changing the pressure within the 3 way switching valve responds to the air signal by changing the air signal direction to supply air to the pneumatic cylinder, causing the cylinder to extend to 4 inches, lifting the front of the cradle holding the barrel. After reaching the set extension point, the limit switch located on B2 is opened sending air signal to the timer located on B7 to close the timer from sending an air signal to the 3 way switching valve allowing it to recharge. When the timer is closed and stops sending an air signal to the 3 way switching valve, the spring loaded 3 way valve closes and stops air signal to the pneumatic cylinder allowing it to contract and releasing the air pressure thru the two way valve system on the cylinder. This restarting the cycle, which continues until the emergency pneumatic shutoff and control valve is turned off, shutting off the air supply.

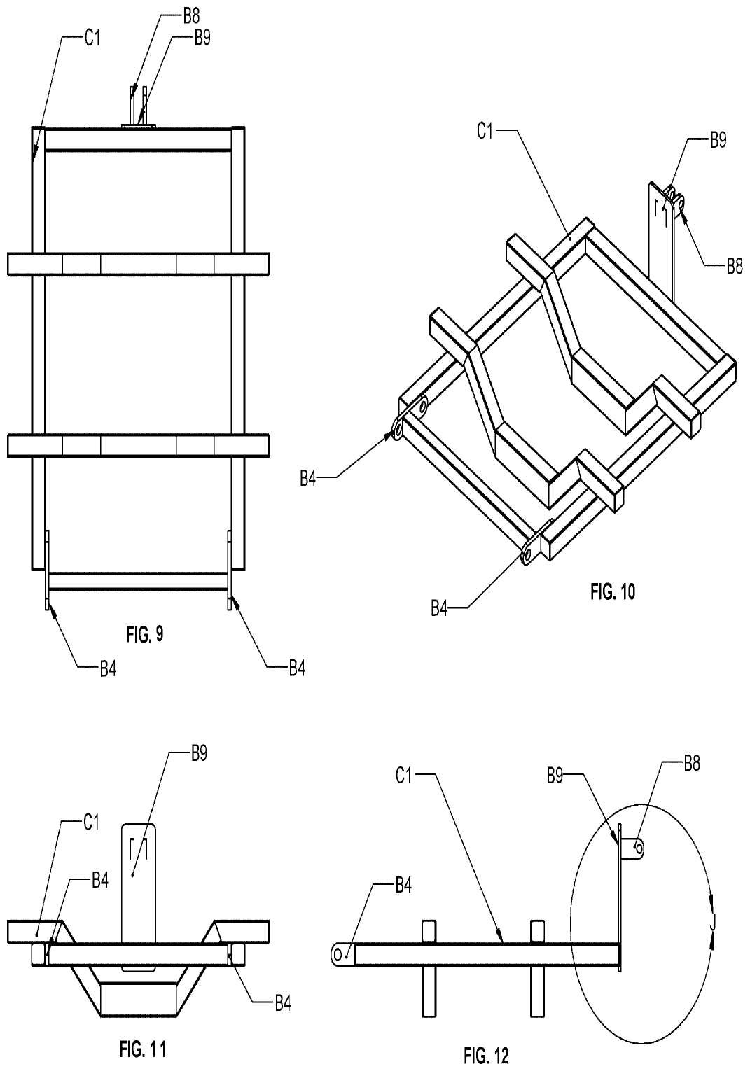

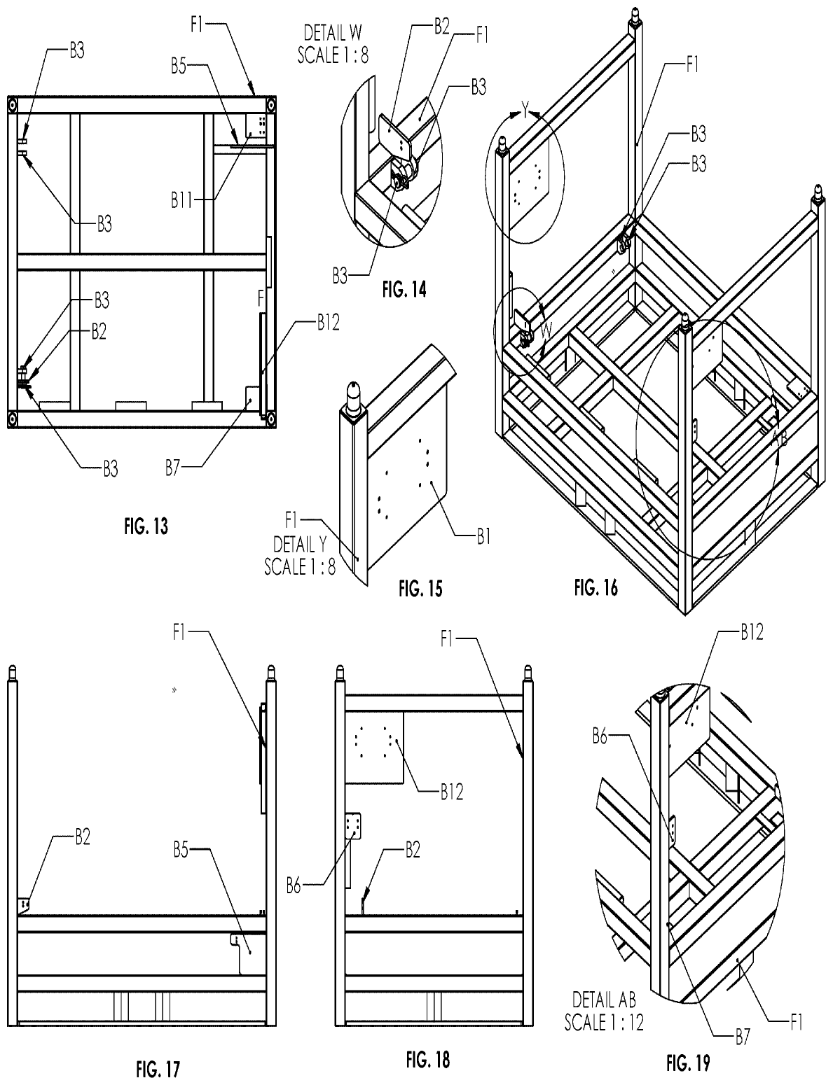

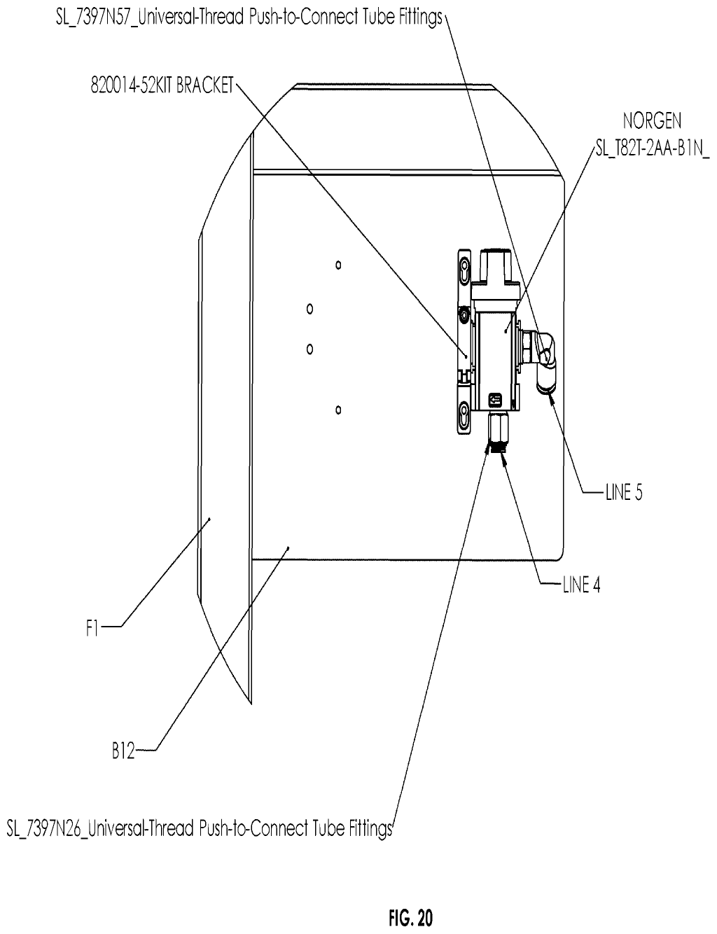

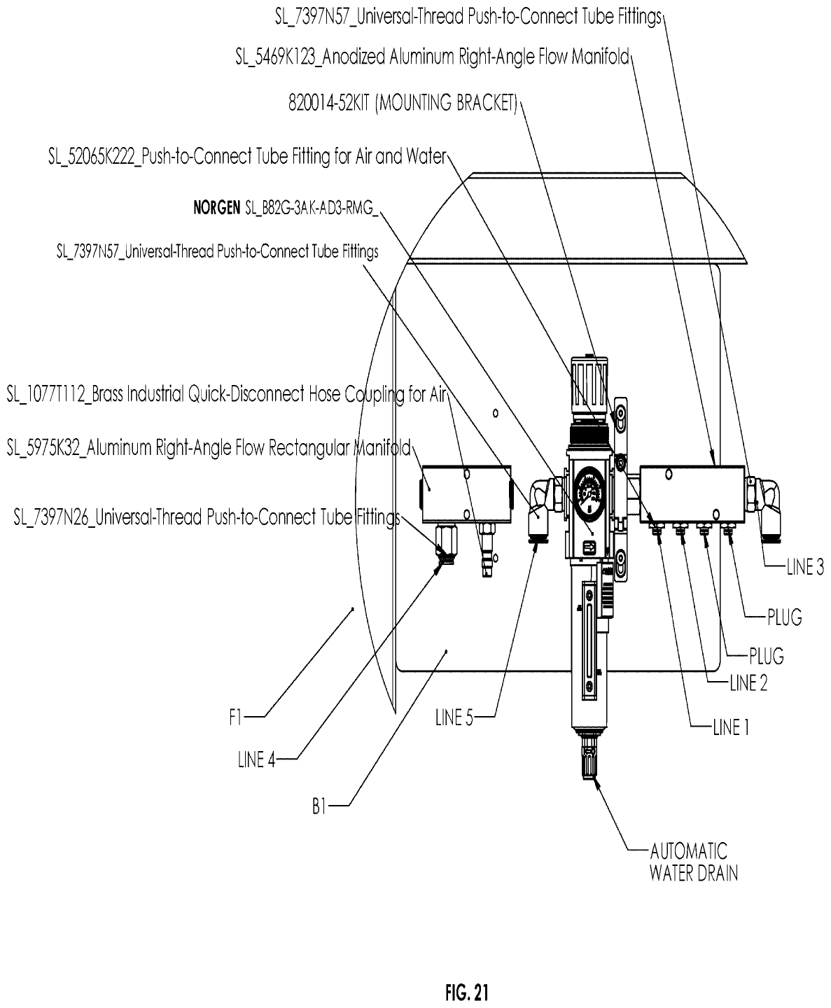

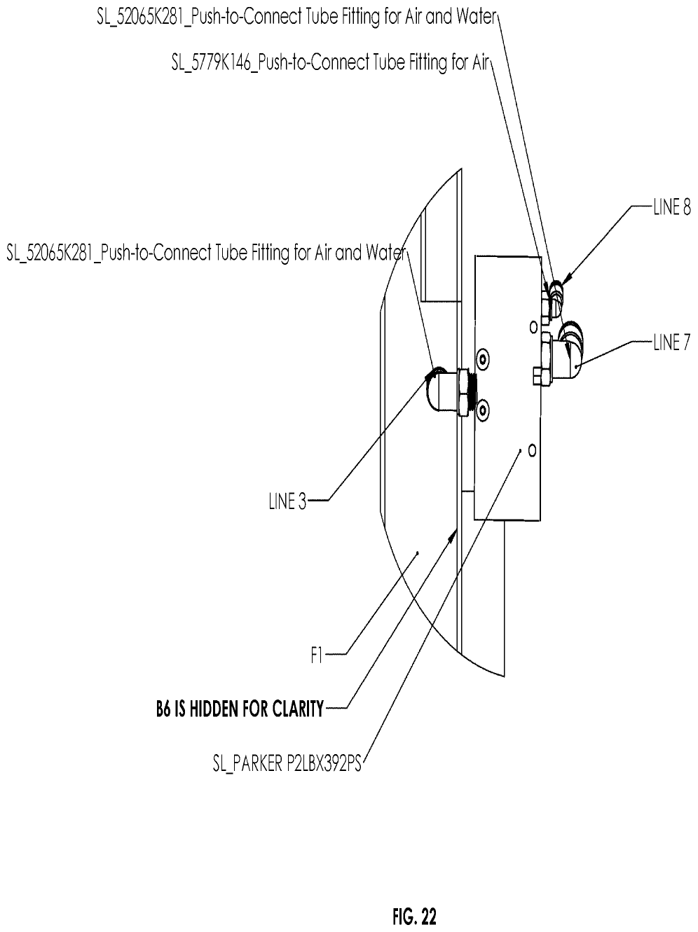

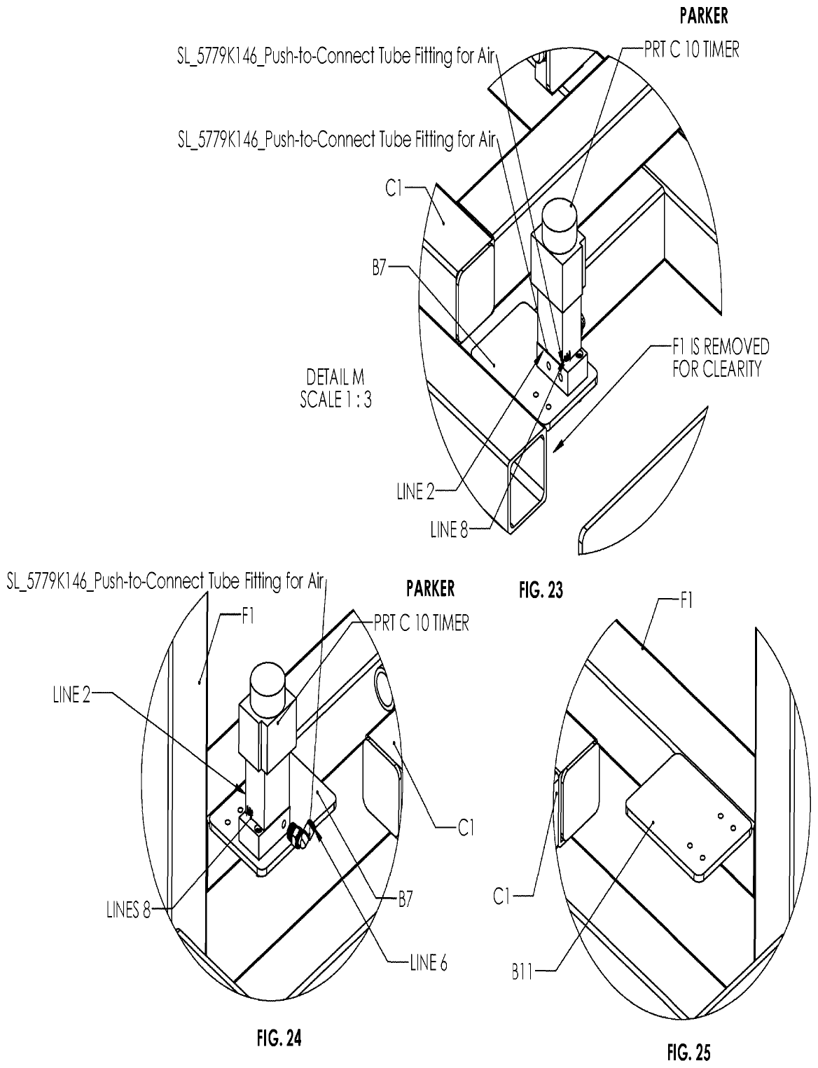

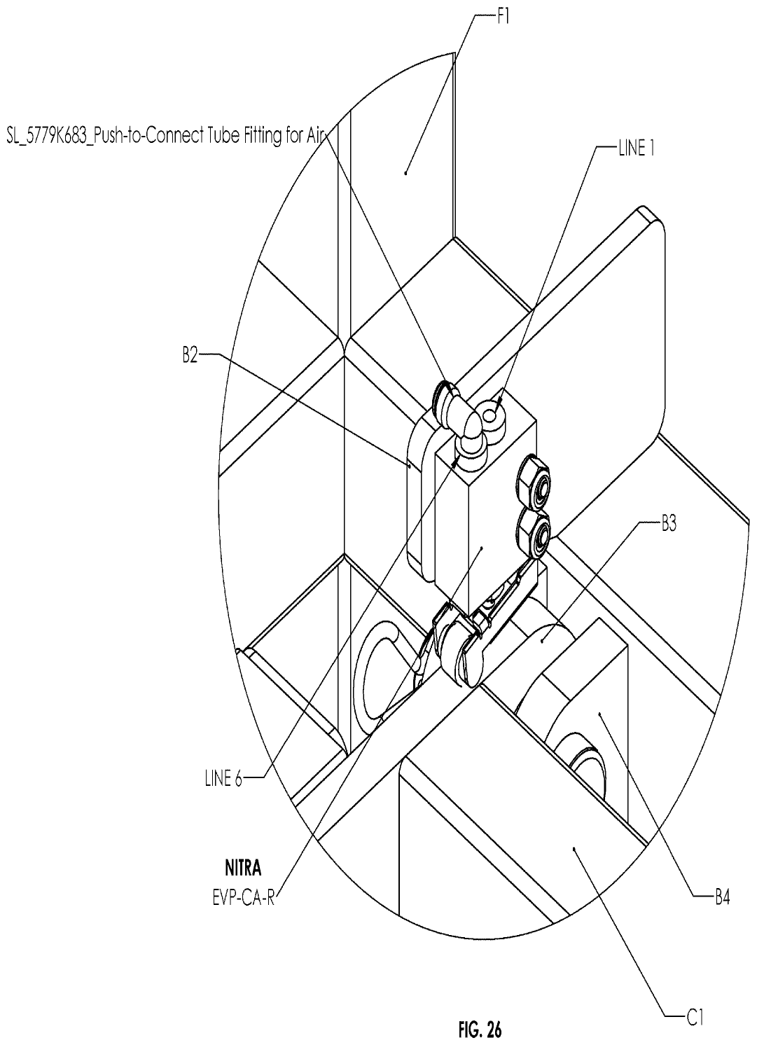

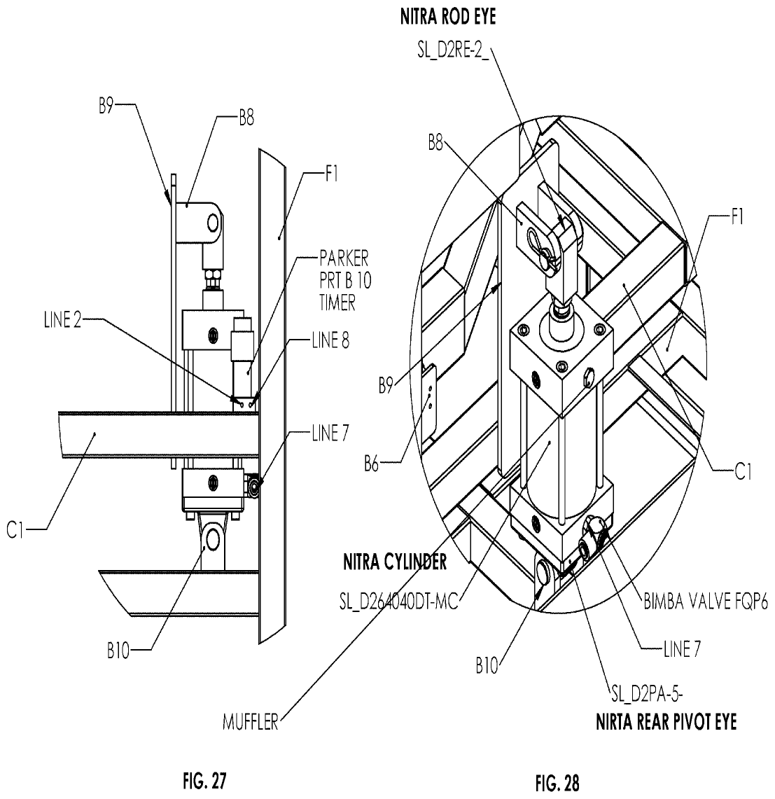

As can be seen in FIGS. 9, 10, 11, and 12, the floating cradle, when viewed from the front or back, has two barrel support sections, each having a shape from left to right of a flat portion, a portion that angles down at 45 degrees, another flat portion, a portion that angles up at 45 degrees and is the same length as the portion angled down, and another flat portion the same length as the initial flat portion. These barrel support sections in the center equal portion of C1 are what the barrel is directly supported by. The barrel support sections are supported in turn by the floating cradle frame (C1) which is rectangular. The air cylinder attaches to an air cylinder mounting bracket B8 which is welded to B9 the front of the floating cradle (C1). The back of the floating cradle connects to the Frame (F1) via B3 mounts on the frame (F1) and connects to B4 on the cradle (C1). (B4) mounts have a steel bushing with a ½″ diameter steel pin.

While illustrative embodiments of the invention have been shown and described, variations and alternative embodiments will occur to those skilled in the art. Such variations and alternative embodiments can be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom. Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112 (f), unless the element is expressly recited using the exact phrase “means for . . . ” and no method or process step herein is to be construed under the provisions of 35 U.S.C. section 112 (f) unless the step, or steps, are expressly recited using the exact phrase “step(s) for . . . ”.

1. A modular storage and mixing system for barrels, each module comprising:
an external frame, a floating cradle, and a pneumatic motion-controlled system wherein the pneumatic motion controlled system further comprises a pressure regulator, a drier, an emergency cutoff and control valve, a pneumatic variable timer, a three way direction control valve, a limit switch, and a pneumatic cylinder.

2. The modular storage and mixing system for barrels of claim 1, wherein the pneumatic cylinder lifts the floating cradle holding the barrel and agitates the contents therein.

3. The modular storage and mixing system for barrels of claim 1, wherein the external frame and floating cradle are each made of 2×2 inch steel tubing.

4. The modular storage and mixing system for barrels of claim 1, wherein the external frame is configured to permit stacking of up to 3 units via the inclusion of pins above and indentations for pins to be inserted into below, such that when stacked the units interlock.

5. The modular storage and mixing system for barrels of claim 1, wherein the pneumatic motion controlled system is configured such that the emergency cutoff and control valve can be used to turn the motion system on and off, and the operation of the system to pressurize and depressurize the pneumatic cylinder to agitate the barrel to mix the content of the barrel is controlled by the relative pressures of the lines connected to the three way switching valve.
